(19) United States
(12) Patent Application Publication
(10) Pub. No.: US 2026/0326745 A1
(43) Pub. Date: Oct. 22, 2026

(54) SYSTEM AND METHOD FOR MANEUVERING A VEHICLE TO REDUCE YAW

(71) Applicant: GM GLOBAL TECHNOLOGY OPERATIONS LLC, Detroit, MI (US)

(72) Inventors: Richard Romano, Shelby Township, MI (US); Paul G. Otanez, Franklin, MI (US); Nikolai K. Moshchuk, Grosse Pointe, MI (US); SeyedAlireza Kasaiezadeh Mahabadi, Waterloo (CA)

(73) Assignee: GM GLOBAL TECHNOLOGY OPERATIONS LLC, Detroit, MI (US)

(21) Appl. No.: 19/185,453

(22) Filed: Apr. 22, 2025

(51) Int. Cl. B60W 30/045; B60W 50/08

(52) U.S. Cl. CPC B60W 30/045; B60W 50/085; B60W 2540/18; B60W 2710/207; B60W 2720/12; B60W 2720/14

(57) ABSTRACT

A method of operating a vehicle includes receiving a lateral motion request from a driver lateral selection device on the vehicle while the vehicle is in motion, determining a lateral velocity and yaw rate for the vehicle that satisfies the lateral motion request, and determining a front road wheel path and a rear road wheel path that satisfies the lateral velocity and yaw rate for the vehicle. The method also includes directing front road wheels of the vehicle to follow the front road wheel path with a front wheel steering system and directing rear road wheels on the vehicle to follow the rear road wheel path with a rear wheel steering system.

### BACKGROUND

The present disclosure relates to vehicle maneuvering, and more particularly, to a system and method for maneuvering a vehicle to reduce yaw.

A number of factors can contribute to the comfort of occupants in a vehicle during a trip. One approach to improve occupant comfort is through suspension tuning to remove harshness from variations in the road surface. Additionally, roads with certain profiles, such as curvy roads, can lead occupants to experience motion due to the cyclic movement of the vehicle. In these situations, the driver of the vehicle may reduce the speed of the vehicle to improve occupant comfort or select a different route.

### SUMMARY

Disclosed herein is a method of operating a vehicle. The method includes receiving a lateral motion request from a driver lateral selection device on the vehicle while the vehicle is in motion, determining a lateral velocity and yaw rate for the vehicle that satisfies the lateral motion request, and determining a front road wheel path and a rear road wheel path that satisfies the lateral velocity and yaw rate for the vehicle. The method also includes directing front road wheels of the vehicle to follow the front road wheel path with a front wheel steering system and directing rear road wheels on the vehicle to follow the rear road wheel path with a rear wheel steering system.

In one aspect of the disclosure the lateral motion request is based at least partially on a position of a hand wheel on the vehicle determined by a hand wheel position sensor.

In one aspect of the disclosure the front road wheel path includes a maximum front road wheel angle in a first rotational direction for each of the front road wheels and the rear road wheel path includes a maximum rear road wheel angle in a first rotational direction.

In one aspect of the disclosure the front road wheel path includes a maximum front road wheel angle in a first rotational direction and a maximum front road wheel angle in a second rotational direction.

In one aspect of the disclosure the rear road wheel path includes a maximum rear road wheel angle in a first rotational direction and a maximum rear road wheel angle in a second rotational direction.

In one aspect of the disclosure the lateral motion request from the driver lateral selection device includes a desired direction and a magnitude.

In one aspect of the disclosure the magnitude includes one of a set of predetermined magnitude levels.

In one aspect of the disclosure the yaw rate determined that satisfies the lateral motion request is based on the magnitude of the lateral motion request from the driver lateral selection device.

In one aspect of the disclosure the front wheel steering system includes a steer-by-wire system with at least one front wheel actuator configured to generate the front road wheel path.

In one aspect of the disclosure the rear wheel steering system includes a steer-by-wire system with at least one rear wheel actuator configured to generate the rear road wheel path.

Disclosed herein is a non-transitory computer-readable storage medium embodying programmed instructions which, when executed by a processor, are operable for performing a method. The method includes receiving a lateral motion request from a driver lateral selection device on a vehicle while the vehicle is in motion, determining a lateral velocity and yaw rate for the vehicle that satisfies the lateral motion request, and determining a front road wheel path and a rear road wheel path that satisfies the lateral velocity and yaw rate for the vehicle. The method also includes directing front road wheels of the vehicle to follow the front road wheel path with a front wheel steering system and directing rear road wheels on the vehicle to follow the rear road wheel path with a rear wheel steering system.

Disclosed herein is a vehicle. The vehicle includes a body at least partially defining a passenger cabin, a front steering system configured to generate a front road wheel angle with a pair of front wheels, a rear steering system configured to generate a rear road wheel angle with a pair of rear wheels, at least one driver lateral selection device located within the passenger cabin, a hand wheel located within the passenger cabin and in communication with a hand wheel position sensor. The vehicle also includes a controller in electrical communication with the front steering system, the rear steering system, the at least one driver lateral selective device, and the hand wheel position sensor. The controller configured to receive a lateral motion request from the at least one driver lateral selection device on the vehicle while the vehicle is in motion, determine a lateral velocity and yaw rate for the vehicle that satisfies the lateral motion request, determine a front road wheel path and a rear road wheel path that satisfies the lateral velocity and yaw rate for the vehicle.

The controller is also configured to direct front road wheels of the vehicle to follow the front road wheel path with a front wheel steering system and directing rear road wheels on the vehicle to follow the rear road wheel path with a rear wheel steering system.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 schematically illustrates an example vehicle having a front steering system and a rear steering.

FIG. 2 illustrates an expanded control diagram for maneuvering the vehicle of FIG. 1.

FIG. 3 illustrates an example method of maneuvering the vehicle of FIG. 1.

FIG. 4 illustrates an example path for the vehicle of FIG. 1.

FIG. 5 illustrates another example path for the vehicle of FIG. 1.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

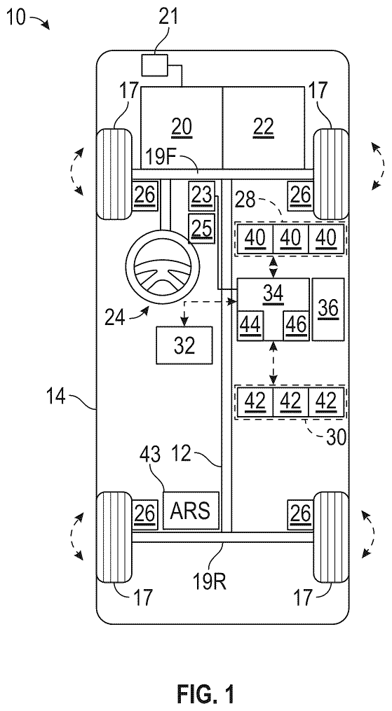

With reference to FIG. 1, the vehicle 10 generally includes a chassis 12, a body 14, front and rear wheels 17. The body 14 is arranged on the chassis 12 and substantially encloses components of the vehicle 10 and defines a passenger cabin. The body 14 and the chassis 12 may jointly form a frame. The wheels 17 are each rotationally coupled to the chassis 12 near a respective corner of the body 14. The vehicle wheels 17 are supported by a front axle 19F and a rear axle 19R.

As shown, the vehicle 10 generally includes a propulsion system 20, a transmission system 22, a steering system 24, a brake system 26, a sensor system 28, an actuator system 30, at least one driver lateral selection device 32, at least one controller 34, and a communication system 36. The propulsion system 20 may, in various embodiments, include an electric machine such as a traction motor and/or a fuel cell propulsion system. The vehicle 10 further includes a battery (or battery pack) 21 electrically connected to the propulsion system 20. Accordingly, the battery pack 21 is configured to store electrical energy and to provide electrical energy to the propulsion system 20. Additionally, the propulsion system 20 may include an internal combustion engine. The transmission system 22 is configured to transmit power from the propulsion system 20 to the vehicle wheels 17 according to selectable speed ratios. According to various embodiments, the transmission system 22 may include a step-ratio automatic transmission, a continuously variable transmission, or other appropriate transmission. The brake system 26 is configured to provide braking torque to the vehicle wheels 17. The brake system 26 may, in various embodiments, include friction brakes, brake by wire, a regenerative braking system such as an electric machine, and/or other appropriate braking systems. The steering system 24 influences a position of the vehicle wheels 17. While depicted as including a steering wheel for illustrative purposes, in some embodiments contemplated within the scope of the present disclosure, the steering system 24 may not include a steering wheel.

The sensor system 28 includes one or more sensors 40 (i.e., sensing devices) that sense observable conditions of the exterior environment and/or the interior environment of the vehicle 10. The sensors 40 are in communication with the controller 34 and may include, but are not limited to, one or more radars, one or more light detection and ranging (lidar) sensors, one or more ground penetrating radar (GPR) sensors, one or more global positioning systems (GPS) devices, one or more cameras (e.g., optical cameras and/or thermal cameras, such as a rear camera and/or a front camera), brake pedal position sensor, accelerator pedal position sensor, steering angle sensor, speed sensor, wheel speed sensor, ride height sensors, steering angle sensor, ultrasonic sensors, one or more inertial measurement units (IMUs), and/or other sensors.

The actuator system 30 includes one or more actuator devices 42 that control one or more vehicle features such as, but not limited to, the propulsion system 20, the transmission system 22, the steering system 24 including front and rear steering components, and the brake system 26. In this disclosure, the steering system 24 includes a front steering system 25 for turning the front wheels 17 and a rear steering system 43, such as an active rear steer (ARS) system, for steering the rear wheels 17 independently of the front wheels 17. Furthermore, the front steering system and the rear steering system are each drive-by-wire systems without a direct mechanical connection between the steering wheel and the wheels 17. In various embodiments, the vehicle features can further include interior and/or exterior vehicle features such as, but are not limited to, doors, a trunk, and cabin features such as air, music, lighting, etc. (not numbered). For example, the actuator devices 42 include an accelerator pedal, a brake pedal, etc.

The controller 34 includes at least one processor 44 and a non-transitory computer readable storage device or medium 46. The processor 44 can be a custom made or commercially available processor, a central processing unit (CPU), a graphics processing unit (GPU), an auxiliary processor among several processors associated with the controller 34, a semiconductor-based microprocessor (in the form of a microchip or chip set), a microprocessor, a combination thereof, or generally a device for executing instructions. The computer readable storage device or medium 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or medium 46 may be implemented using a number of other memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although a single controller 34 is shown in FIG. 1, embodiments of the vehicle 10 may include a number of controllers 34 that communicate over a suitable communication medium or a combination of communication mediums and that cooperate to process the sensor signals, perform logic, calculations, methods, and/or algorithms, and generate control signals to automatically control features of the vehicle 10.

The vehicle 10 includes a human-machine interface (HMI) 23, which may be a center stack screen or a drive information center. The HMI 23 interacts with a user to show information and receives confirmation, activation, cancellation commands, etc. The HMI 23 may be configured as an alarm, such as a speaker to provide a sound, a haptic feedback in a vehicle seat or other object, a visual display, or other device suitable to provide a notification to the vehicle operator of the vehicle 10. The HMI 23 is in electronic communication with the controller 34 and is configured to receive inputs from a user (e.g., vehicle operator). Accordingly, the controller 34 is configured to receive inputs from the user via the HMI 23. The HMI 23 includes a display configured to display information to the user (e.g., vehicle operator or passenger) and may include one or more speakers to provide an auditable notification to the vehicle operator.

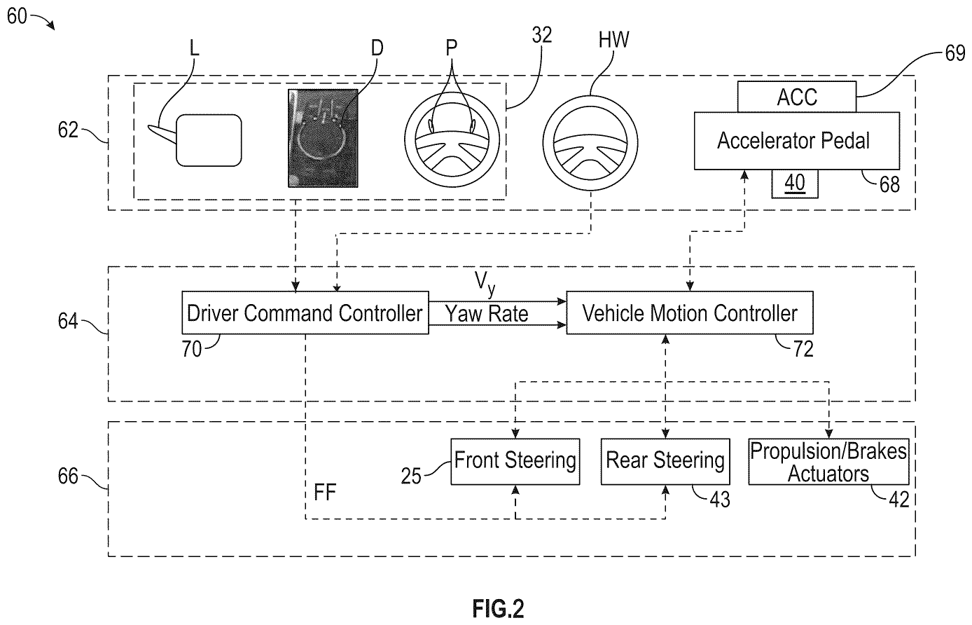

FIG. 2 illustrates an expanded control diagram 60 for maneuvering the vehicle 10. The control diagram 60 includes a driver input portion 62, a control portion 64, and an actuator portion 66. The driver input portion 62 includes the at least one driver lateral selection device 32, a hand wheel HW forming a portion of the steering system 24, and an acceleration pedal 68 connected to an accelerator pedal position sensor 40. An active cruise control system (ACC) 69 can also be associated with the accelerator pedal 68.

In the illustrated example, the driver lateral selection device 32 can include a dial D on a center counsel, a lever L on a steering column, or paddles P located adjacent to the hand wheel HW. Signals from the driver lateral selection device 32 and the hand wheel HW are sent to a driver command controller 70. The driver command controller 70 interprets the signals from the driver lateral selection device 32 and the hand wheel HW into a lateral velocity V_{y} and a yaw rate to describe the desired lateral movement of the vehicle 10. The lateral velocity V_{y} and the yaw rate are then sent to a vehicle motion controller 72. Additionally, the lateral velocity V_{y} and the yaw rate can be provided directly to the front steering system 25 and the rear steering system 43 through a feed forward FF communication to increase response time if desired. The driver command controller 70 can also select the lateral velocity V_{y} and the yaw rate based on road friction in the area of the vehicle maneuver.

When vehicle motion controller 72 receives the lateral velocity V_{y} and the yaw rate, the vehicle motion controller 72 turns these parameters into control signals that are sent to the front steering system 25 to create a road wheel angle with the front wheels 17 and the rear steering system 43 to create a road wheel angle with the rear wheels 17. The vehicle motion controller 72 can also send control signals to the brakes 26 and the accelerator pedal 68 to further control lateral movement of the vehicle 10.

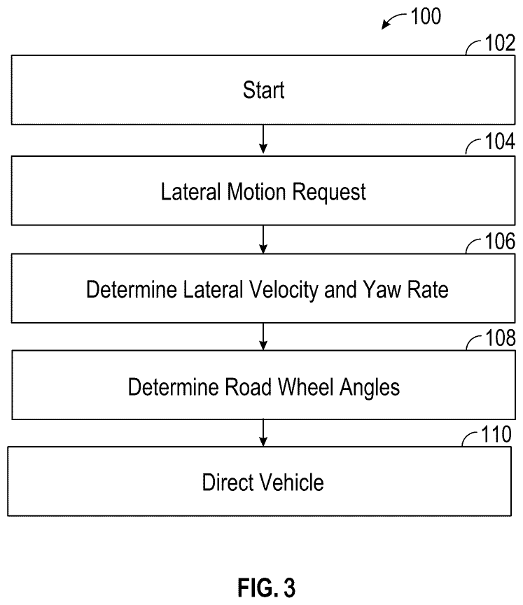

FIG. 3 illustrates an example method 100 of maneuvering the vehicle 10 along a roadway. One feature of this disclosure is that it allows the vehicle 10 to move laterally along a roadway under certain situations with a reduced yaw rate to improve vehicle occupant comfort. The example method 100 begins at block 102 (“Start”). From block 102, the method proceeds to block 104.

At block 104 (“Lateral Motion Request”), the method 100 receives a lateral motion request from one of the driver lateral selection devices 32. One feature of this disclosure is that the lateral motion requested by one of the driver lateral selection devices 32 is separate from an input received by the hand wheel HW. When the lateral motion request is received from the dial D, a direction of rotation corresponds to a desired lateral direction of movement for the vehicle and a magnitude of rotational travel of the dial D corresponds to a rate of lateral change desired in the lateral direction. Similarly, when the driver lateral selection device 32 includes the leveler L, the direction of lateral motion can be selected similar to a blinker and a magnitude of lateral change can correspond to a length of time that the lever L remains depressed in the given direction or a magnitude of travel. Furthermore, when the driver lateral selection device 32 includes the paddle P, the direction of lateral motion corresponds to whether the left or right paddle P was selected and the rate of lateral change can correspond to a length of time that the selected paddle P remained depressed. With the lateral motion request received, the method 100 proceeds to block 106. Furthermore, in one example, the lateral motion request may include input from the hand wheel HW as the hand wheel HW is part of a steer-by-wire steering system on the vehicle 10.

At block 106 (“Determine Lateral Velocity and Yaw Rate”), the lateral velocity and yaw rate for the vehicle 10 are determined that would satisfy the lateral motion requested. In one example, the lateral velocity and yaw rate for the vehicle 10 is based on input from only one of the driver lateral selection devices 32 and in another example, the lateral velocity and yaw rate for the vehicle 10 is based on a combination or blend of inputs from that driver lateral selection devices 32 and the hand wheel HW. As discussed above, the driver command controller 70 determines the lateral velocity and the yaw rate for the vehicle 10 based on the input lateral motion requested. The driver command controller 70 can determine the lateral velocity and the yaw rate based on a look up table or through an algorithm. The method 100 then proceeds to block 108.

At block 108 (“Determine Road Wheel Angles”), the method 100 utilizes the vehicle motion controller 72 to translate the desired lateral velocity and yaw rate into control signals for the front steering system 25 and the rear steering system 43. The control signals from the vehicle motion controller 72 correspond to a road wheel angle for the front wheels 17 and a road wheel angle for the rear wheels 17. The road wheel angles for the front and rear wheels 17 corresponding to front road wheel paths and rear road wheel paths. One feature of this disclosure is that it allows the driver of the vehicle 10 to create lateral movement of the vehicle 10 with little to no yaw rate without providing input into the hand wheel HW. Furthermore, this disclosure also allows a reduction in yaw rate based on input from the driver lateral selection device 32 and hand wheel HW. This improves vehicle occupant comfort while also providing quick vehicle maneuvering responses. With the road wheel angles determined, the method 100 proceeds to block 110.

At block 110 (“Direct Vehicle”), the method 100 directs the front steering system 25 through the vehicle motion controller 72 to create the desired road wheel angle with the front wheels 17 with at least one of the actuator 42, such as the front wheel actuator. Similarly, the method 100 directs the rear steering system 43 through the vehicle motion controller 72 to create the desired road wheel angle with the rear wheels 17 with at least one of the actuators 42, such as the rear wheel actuator. The method 100 can make changes to the vehicle propulsion and braking in addition to steering as discussed below.

Furthermore, depending on the control signals generated to satisfy the lateral motion request, the vehicle motion controller 72 may also direct the actuators 42 to makes changes to vehicle propulsion or braking. For example, the control signals generated by the vehicle motion controller 72 may actuate the brakes 26 at one or more corners of the vehicle 10 to create additional changes to yaw rate beyond those created with the road wheel to satisfy the lateral motion request and/or command torque vectoring by the propulsion actuators.

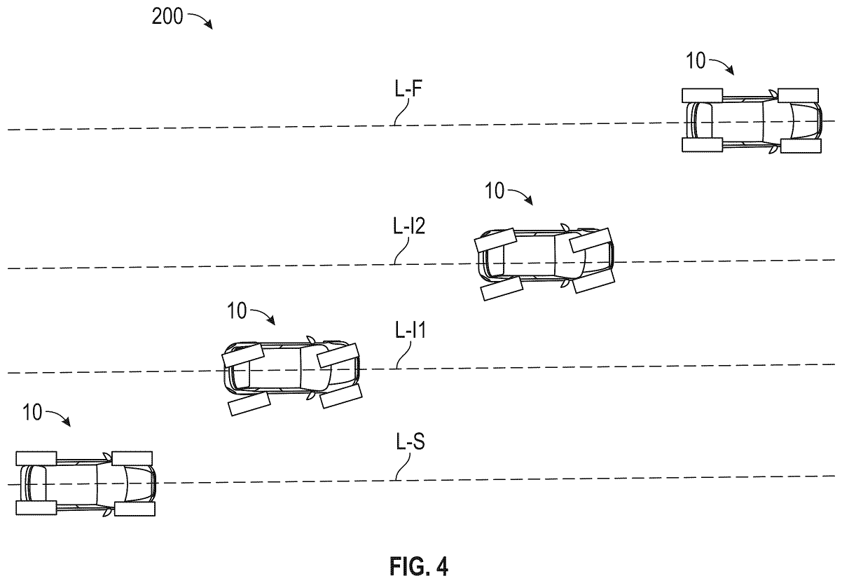

FIG. 4 illustrates a first example vehicle path 200. In the example vehicle path 200, the operator of the vehicle 10 provides a lateral motion request through one of the driver lateral selection devices 32 that could be satisfied with little or no yaw rate for the vehicle 10 but with a lateral velocity. In the illustrated example, the vehicle 10 beings at a starting lateral position L-S and moves through intermediate lateral positions L-I1 and L-I2 before reaching a final lateral position L-F. To accomplish this lateral movement, the front and rear wheels 17 follow front and rear wheel paths, respectively, that begin straight at the starting lateral position L-S and include a maximum front and rear road wheel angle in a first rotational direction at one of the intermediate lateral positions L-I1 or L-I2 before returning to be straight at the final lateral position L-F.

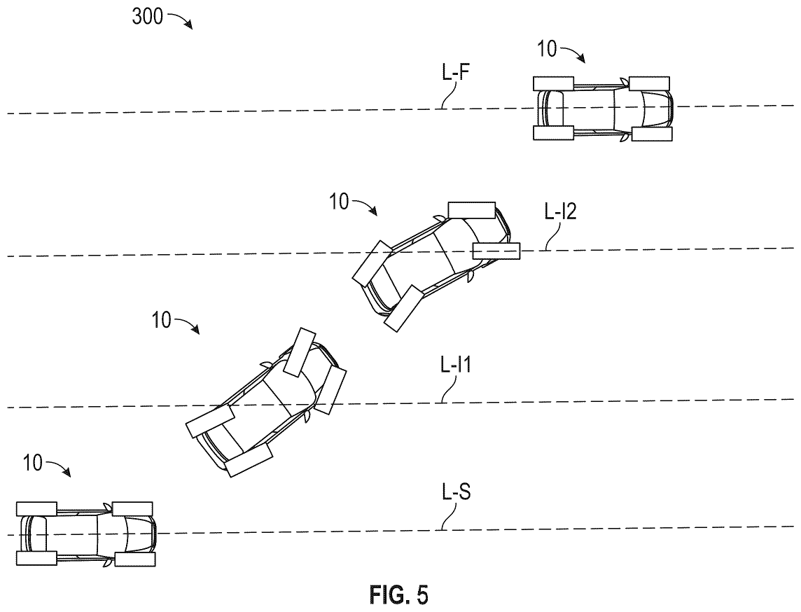

FIG. 5 illustrates a second example vehicle path 300. In the example vehicle path 300, the operator of the vehicle 10 provides a lateral motion request through one of the driver lateral selection devices 32 with or without additional input to the hand wheel HW that required a combination of a lateral velocity and a yaw rate to satisfy. In the illustrated example, the vehicle 10 begins at a starting lateral position L-S and moves through intermediate lateral positions L-I1 and L-I2 before reaching a final lateral position L-F. To accomplish this lateral movement, the front and rear wheels follow front and rear wheel paths, respectively, that begin straight at the starting lateral positions L-S and include a first maximum front and rear road wheel angle in a first rotational direction at the first intermediate lateral positions L-I1. The front and rear wheels also include a second maximum front and rear road wheel angle in a second rotational direction at the second intermediate lateral position L-I2 before returning to straight at the final lateral position L-F.

The example vehicle paths 200 and 300 represent vehicle maneuvers corresponding to varying degrees of predetermined magnitude put into one or more of the driver lateral selection devices 32 and the hand wheel HW.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A method of operating a vehicle, the method comprising:
receiving a lateral motion request from a driver lateral selection device on the vehicle while the vehicle is in motion;
determining a lateral velocity and yaw rate for the vehicle that satisfies the lateral motion request;
determining a front road wheel path and a rear road wheel path that satisfies the lateral velocity and yaw rate for the vehicle; and
directing front road wheels of the vehicle to follow the front road wheel path with a front wheel steering system and directing rear road wheels on the vehicle to follow the rear road wheel path with a rear wheel steering system.

2. The method of claim 1, wherein the lateral motion request is based at least partially on a position of a hand wheel on the vehicle determined by a hand wheel position sensor.

3. The method of claim 1, wherein the front road wheel path includes a maximum front road wheel angle in a first rotational direction for each of the front road wheels and the rear road wheel path includes a maximum rear road wheel angle in a first rotational direction.

4. The method of claim 1, wherein the front road wheel path includes a maximum front road wheel angle in a first rotational direction and a maximum front road wheel angle in a second rotational direction.

5. The method of claim 4, wherein the rear road wheel path includes a maximum rear road wheel angle in a first rotational direction and a maximum rear road wheel angle in a second rotational direction.

6. The method of claim 1, wherein the lateral motion request from the driver lateral selection device includes a desired direction and a magnitude.

7. The method of claim 6, wherein the magnitude includes one of a plurality of predetermined magnitude levels.

8. The method of claim 6, wherein the yaw rate determined that satisfies the lateral motion request is based on the magnitude of the lateral motion request from the driver lateral selection device.

9. The method of claim 1, wherein the front wheel steering system includes a steer-by-wire system with at least one front wheel actuator configured to generate the front road wheel path.

10. The method of claim 1, wherein the rear wheel steering system includes a steer-by-wire system with at least one rear wheel actuator configured to generate the rear road wheel path.

11. A non-transitory computer-readable storage medium embodying programmed instructions which, when executed by a processor, are operable for performing a method comprising:
receiving a lateral motion request from a driver lateral selection device on a vehicle while the vehicle is in motion;
determining a lateral velocity and yaw rate for the vehicle that satisfies the lateral motion request;
determining a front road wheel path and a rear road wheel path that satisfies the lateral velocity and yaw rate for the vehicle; and
directing front road wheels of the vehicle to follow the front road wheel path with a front wheel steering system and directing rear road wheels on the vehicle to follow the rear road wheel path with a rear wheel steering system.

12. The non-transitory computer-readable storage medium of claim 11, wherein the front road wheel path includes a maximum front road wheel angle in a first rotational direction for each of the front road wheels and the rear road wheel path includes a maximum rear road wheel angle in a first rotational direction.

13. The non-transitory computer-readable storage medium of claim 11, wherein the front road wheel path includes a maximum front road wheel angle in a first rotational direction and a maximum front road wheel angle in a second rotational direction.

14. The non-transitory computer-readable storage medium of claim 13, wherein the rear road wheel path includes a maximum rear road wheel angle in a first rotational direction and a maximum rear road wheel angle in a second rotational direction.

15. A vehicle, comprising:
a body at least partially defining a passenger cabin;
a front steering system configured to generate a front road wheel angle with a pair of front wheels;
a rear steering system configured to generate a rear road wheel angle with a pair of rear wheels;
at least one driver lateral selection device located within the passenger cabin;
a hand wheel located within the passenger cabin and in communication with a hand wheel position sensor; and
a controller in electrical communication with the front steering system, the rear steering system, the at least one driver lateral selective device, and the hand wheel position sensor, the controller configured to:
receive a lateral motion request from the at least one driver lateral selection device on the vehicle while the vehicle is in motion;
determine a lateral velocity and yaw rate for the vehicle that satisfies the lateral motion request;
determine a front road wheel path and a rear road wheel path that satisfies the lateral velocity and yaw rate for the vehicle; and
direct front road wheels of the vehicle to follow the front road wheel path with a front wheel steering system and directing rear road wheels on the vehicle to follow the rear road wheel path with a rear wheel steering system.

16. The vehicle of claim 15, wherein the lateral motion request from the at least one driver lateral selection device includes a desired direction and a magnitude.

17. The vehicle of claim 15, wherein the at least one driver lateral selection device includes at least one of a dial, a paddle, or a lever.

18. The vehicle of claim 15, wherein the front wheel steering system includes a steer-by-wire system with at least one front wheel actuator configured to generate the front road wheel path.

19. The vehicle of claim 15, wherein the rear wheel steering system includes a steer-by-wire system with at least one rear wheel actuator configured to generate the rear road wheel path.

20. The vehicle of claim 15, wherein the front road wheel path includes a maximum front road wheel angle in a first rotational direction for the pair of front wheels and the rear road wheel path includes a maximum rear road wheel angle in a first rotational direction for the pair of rear wheels.
